(19) United States
(12) Patent Application Publication
(10) Pub. No.: US 2017/0003860 A1
(43) Pub. Date: Jan. 5, 2017

(54) DISPLAY CONTROL APPARATUS, DISPLAY CONTROL METHOD, AND NON-TRANSITORY COMPUTER-READABLE STORAGE MEDIUM

(71) Applicant: CANON KABUSHIKI KAISHA, Tokyo (JP)

(72) Inventor: Masato Kozakura, Tokyo (JP)

(21) Appl. No.: 15/193,470

(22) Filed: Jun. 27, 2016

(30) Foreign Application Priority Data
Jun. 30, 2015 (JP) 2015-131842

(51) Int. Cl. G06F 3/0484; G06T 11/60

(52) U.S. Cl. CPC G06F 3/04845; G06T 11/60; G06F 3/04847

(57) ABSTRACT

An acquisition unit acquires a captured image. A display control unit causes the captured image to be displayed in the display screen. An operation acceptance unit accepts a predetermined operation in a state in which the captured image is displayed in the display screen. If, in a case where the predetermined operation is performed, the display control unit determines that it has become a timing at which the captured image displayed in the display screen is changed from a first captured image obtained by capturing a first area to a second captured image obtained by capturing a second area different to the first area, the display control unit causes the first captured image to be displayed in the display screen without changing to the second captured image until at least the predetermined operation terminates.

### BACKGROUND OF THE INVENTION

Field of the Invention

The present invention relates to a display control technique.

Description of the Related Art

A camera having a PTZ (pan/tilt/zoom) mechanism can, in relation to pan/tilt/zoom control, cause an image capturing unit of the camera to be driven to face any position by designating an absolute position or a relative position with respect to an operation area of the camera. By causing an image capturing unit of the camera to move in this way, it is possible to scroll a display of an image captured by the image capturing unit. In addition, a camera having a PTZ function can designate a zoom scaling factor with respect to an imaging region of the camera, to cause a reducing scale of the display of the captured image to change. Here, pan/tilt/zoom control can be realized by transmitting a control command to the camera, based on information input to a user interface that is, for example, in an image display device connected to the camera.

Japanese Patent Laid-Open No. 2011-209740 discloses a configuration for changing a reducing scale of a display area. Japanese Patent Laid-Open No. 2011-209740 proposes an apparatus that, if scrolling is instructed while performing a change of a reducing scale of a display area in accordance with an instruction of a user, in addition to stopping the change of the reducing scale and causing the scrolling, returns the display area to the reducing scale before the change of the reducing scale.

Turning and a preset movement are given as examples that correspond to a scroll operation in the camera. However, if, as in Japanese Patent Laid-Open No. 2011-209740, a state before the reducing scale change was performed is returned to in a case in which a reducing scale change and a scroll operation have occurred, a user cannot understand what position is designated in the camera when operation completes. The content handled in Japanese Patent Laid-Open No. 2011-209740 is static content such as a map, and a case of handling dynamic content that may change moment-to-moment, such as a video image is not included. For example, a video image transmitted from a camera is constantly being updated in the camera. In addition, an angle of view itself also changes moment-to-moment during pan/tilt/zoom control according to changes of an image capturing parameter. Thus, when previous content itself is updated at a timing at which a user thinks they performed an operation while watching the captured image, it is difficult to designate a position the user intends.

### SUMMARY OF THE INVENTION

According to the first aspect of the present invention, there is provided a display control apparatus, comprising: an acquisition unit configured to acquire a captured image that is captured by an image capturing device; a display control unit configured to cause the captured image acquired by the acquisition unit to be displayed in a display screen; and an operation acceptance unit configured to accept a predetermined operation in a state in which the captured image is displayed in the display screen, wherein if, in a case where the predetermined operation is performed, the display control unit determines that it has become a timing at which the captured image displayed in the display screen is changed from a first captured image obtained by capturing a first area to a second captured image obtained by capturing a second area different to the first area, the display control unit causes the first captured image to be displayed in the display screen without changing to the second captured image until at least the predetermined operation terminates.

According to the second aspect of the present invention, there is provided a display control method, comprising: acquiring a captured image that is captured by an image capturing device; performing a display control to cause a display screen to display the captured image; and accepting a predetermined operation in a state in which the captured image is displayed in the display screen, wherein if, in a case where the predetermined operation is performed, it is determined in the display control that it has become a timing at which the captured image displayed in the display screen is changed from a first captured image obtained by capturing a first area to a second captured image obtained by capturing a second area different to the first area, the first captured image is caused to be displayed in the display screen without changing to the second captured image until at least the predetermined operation terminates.

According to the third aspect of the present invention, there is provided a non-transitory computer-readable storage medium storing a computer program for causing a computer to function as: an acquisition unit configured to acquire a captured image that is captured by an image capturing device; a display control unit configured to cause the captured image acquired by the acquisition unit to be displayed in a display screen; and an operation acceptance unit configured to accept a predetermined operation in a state in which the captured image is displayed in the display screen, wherein if, in a case where the predetermined operation is performed, the display control unit determines that it has become a timing at which the captured image displayed in the display screen is changed from a first captured image obtained by capturing a first area to a second captured image obtained by capturing a second area different to the first area, the display control unit causes the first captured image to be displayed in the display screen without changing to the second captured image until at least the predetermined operation terminates.

Further features of the present invention will become apparent from the following description of exemplary embodiments (with reference to the attached drawings).

### BRIEF DESCRIPTION OF THE DRAWINGS

FIG. 1 is a block diagram illustrating an example configuration of a system.

FIG. 2 is a view illustrating an example of a display of a user interface 299.

FIG. 3 is a view for explaining a box zoom.

FIG. 4 is a classification view of methods for operating for designating image capturing parameters.

FIG. 5 is a flowchart illustrating an operation of an image display device 200.

FIG. 6 is a flowchart illustrating an operation of the image display device 200.

FIG. 7 is a view illustrating an example of a display in step S507.

FIG. 8 is a flowchart illustrating an operation of the image display device 200.

FIG. 9 is a block diagram illustrating an example of a hardware configuration of a computer apparatus.

### DESCRIPTION OF THE EMBODIMENTS

Below, explanation will be given for embodiments of present invention with reference to the accompanying drawings. Note that embodiments described below merely illustrate examples of specifically implementing the present invention, and are only specific embodiments of configuration defined in the scope of the claims.

### First Embodiment

An information processing apparatus according to the present embodiment is an information processing apparatus that controls an image capturing parameter of an image capturing device. Here, the image capturing parameter in the present embodiment indicates a parameter relating to an operation such as pan, tilt, zoom (angle of view) of the image capturing device. Below, explanation is given of an example of an information processing apparatus that operates as follows. Specifically, an image received from the image capturing device is caused to be displayed on a display screen. Because operation of the image capturing device is controlled if it is detected that an operation for changing an image capturing parameter of the image capturing device has started, control is performed so that an image received from the image capturing device at the timing of the detection is displayed on the display screen until it is detected that the operation has completed. If it is detected that the operation has completed, control is performed so as to cause an image received from the image capturing device to be displayed on the display screen at a timing from the completion of the operation onward.

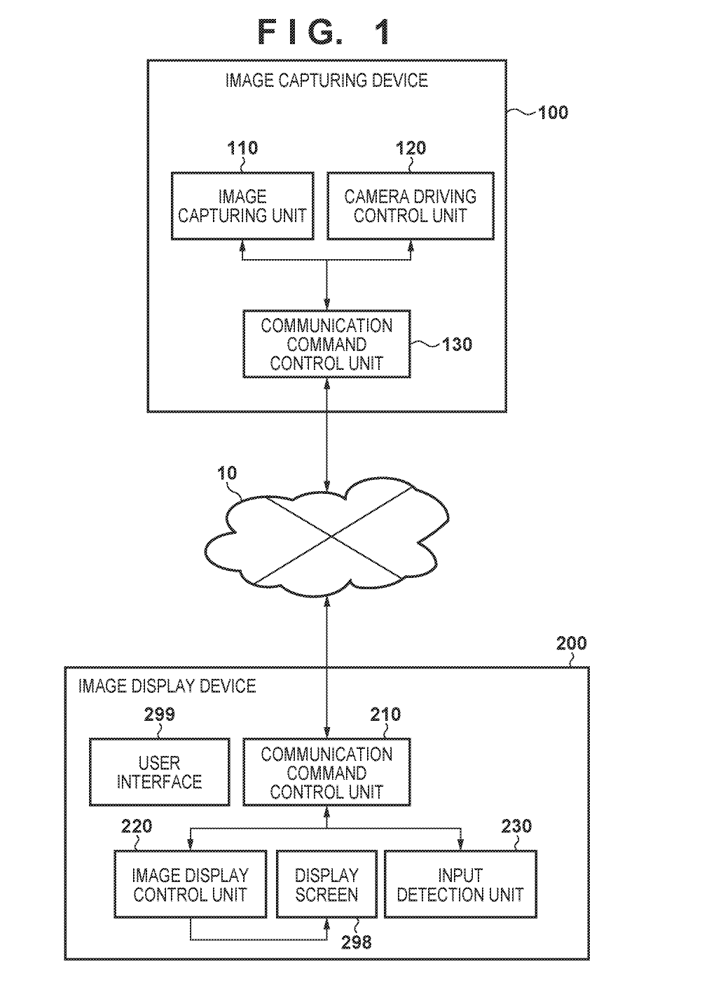

Firstly, explanation is given using the block diagram of FIG. 1 regarding an example configuration of a system that includes an information processing apparatus according to the present embodiment. As illustrated in FIG. 1, the system according to the present embodiment has an image capturing device 100 and an image display device 200, and the image capturing device 100 and the image display device 200 are connected via a network 10. The network 10 may be a LAN such as Ethernet (registered trademark), it may be the Internet, and it may be wireless or wired. In other words, the network 10 is not limited to a network of a particular configuration.

Firstly, explanation is given regarding the image capturing device 100. The image capturing device 100 is a network camera, for example. An image captured in the image capturing device 100 is transmitted to the image display device 200 via the network 10. In addition, a user can set (change) an image capturing parameter of the image capturing device 100 by operation on the image display device 200.

An image capturing unit 110 is something that performs image capturing of an image, and an image capturing parameter thereof, such as for pan, tilt, zoom (angle of view), is controlled by a camera driving control unit 120. A communication command control unit 130 transmits, via the network 10, an image captured by the image capturing unit 110 to the image display device 200. In the present embodiment, the image capturing unit 110 is something that captures a moving image (a plurality of images), and the communication command control unit 130 is something that transmits an image of each frame of the moving image, after performing appropriate compression encoding. However, what the image capturing unit 110 captures is not limited to a moving image, and may be a still image (one image) captured at regular intervals. The format in which the communication command control unit 130 transmits an image is not limited to a particular configuration. In other words, the format of an image may be any format, such as JPEG or H.264, if it is a format that can be processed by an encoder in the image capturing device 100 and a decoder in an image display control unit 220.

The camera driving control unit 120 controls an image capturing parameter of the image capturing unit 110 based on a command that the communication command control unit 130 received from the image display device 200. In addition, the camera driving control unit 120 manages current image capturing parameters or a driving state (for example, “driving” or “non-driving”) of the image capturing unit 110. The communication command control unit 130 periodically or aperiodically transmits to the image display device 200 this information (a driving state or a current image capturing parameter) that the camera driving control unit 120 manages.

Next, explanation is given regarding the image display device 200. The image display control unit 220 acquires (after decoding as necessary) an image that a communication command control unit 210 received from the image capturing device 100 via the network 10, and displays a user interface 299 that includes the acquired image on a display screen 298.

An example of a user interface is one in which a slider bar is operated to designate a position of a display area, and buttons indicating a plus direction or a minus direction of a driving direction is operated to designate the driving direction of a camera. With such a configuration, by operating the slider bar or the buttons to designate a position of the display area or the driving direction of the camera, it is possible to cause the display area to move (scroll). Also, a method of camera control in accordance with a specific operation in a display area has also been proposed. For example, there is one in which by designating a point in a display area, a control command that causes a camera to be driven so that corresponding coordinates become a center of the angle of view is transmitted. There is also one in which, by the performance of a drag operation in a direction with an optional point in the display area as a start point, a control command that controls the camera so as to face in a vector direction from the drag start point is transmitted. There is also one in which, by drawing a rectangle of an optional area in an image display area, a control command that controls a camera so as to match an angle of view to the rectangle is transmitted. Below, a method in which pan/tilt/zoom control is performed by drawing a rectangle in an image display area is referred to as box zoom, and a method in which a camera is controlled so that a point designated in an image display area is centered on is referred to as click centering.

An input detection unit 230 is configured by a keyboard, a mouse, or the like, and by operation by an operator (user) of the image display device 200, it is possible to input various instructions to the image display device 200. For example, a user who operates the image display device 200 performs input of an operation to the user interface 299 by operating the input detection unit 230. Below, explanation is given with the input detection unit 230 being a mouse as an example.

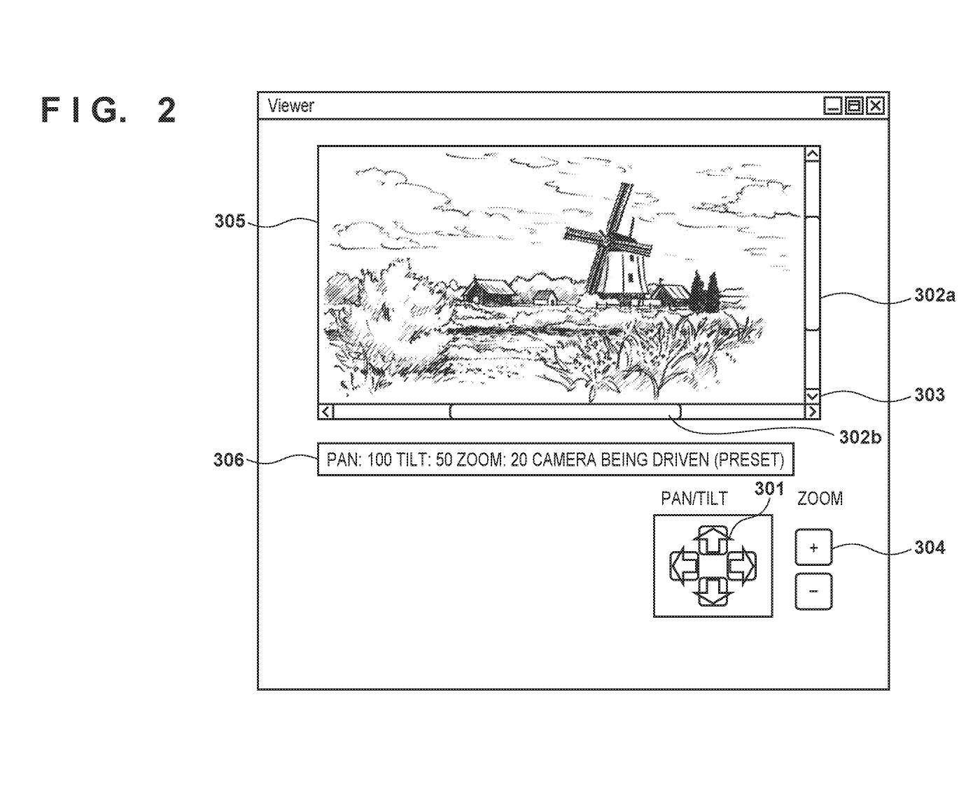

An example of a display of the user interface 299 by the image display control unit 220 is illustrated in FIG. 2. The communication command control unit 210 displays in a display area 305 an image received from the image capturing device 100 via the network 10.

Buttons 301 are configured by buttons for controlling a pan angle and a tilt angle of the image capturing unit 110. For example, each time a user operates the mouse to cause a mouse cursor to move to a position of an up button (the button on which an upward arrow is drawn in the buttons 301) and performs a click operation there, it is possible to input an instruction for causing the tilt angle to increase by a predetermined angle. Also, each time the user operates the mouse to cause a mouse cursor to move to a position of a down button (the button on which a downward arrow is drawn in the buttons 301) and performs a click operation there, it is possible to input an instruction for causing the tilt angle to decrease by the predetermined angle. Also, each time the user operates the mouse to cause a mouse cursor to move to a position of a left button (the button on which a leftward arrow is drawn in the buttons 301) and then performs a click operation there, it is possible to input an instruction for causing a pan angle to decrease by a predetermined angle. Also, each time the user operates the mouse to cause a mouse cursor to move to a position of a right button (the button on which a rightward arrow is drawn in the buttons 301) and then performs a click operation there, it is possible to input an instruction for causing a pan angle to increase by the predetermined angle.

Buttons 304 are configured by buttons for controlling a zoom of the image capturing unit 110. For example, each time a user operates the mouse to cause a mouse cursor to move to a position of a plus button (the button on which a “+” is drawn in the buttons 304) and performs a click operation there, it is possible to input an instruction for causing a zoom scaling factor to increase by a predetermined amount. Also, each time a user operates the mouse to cause a mouse cursor to move to a position of a minus button (the button on which a “−” is drawn in the buttons 304) and performs a click operation there, it is possible to input an instruction for causing a zoom scaling factor to decrease by a predetermined amount.

Each time the buttons 301 and 304 are clicked, the communication command control unit 210 generates a command that indicates instruction content that is instructed by the clicked button, and transmits it to the image capturing device 100 via the network 10. However, configuration may be taken such that timing of the generation and transmission of the command by the communication command control unit 210 is not each time a click is made. For example, configuration may be taken such that command generation and transmission are not performed while a button is continuously pressed, but generation and then transmission of a command that instructs a pan angle/tilt angle/zoom control amount in accordance with a length of time of the pressing or the like, is performed after the button press has completed.

A slider bar 302a is something for causing the tilt angle of the image capturing unit 110 to increase/decrease by causing the slider bar 302a to move up or down. For example, it is possible for a user to increase the tilt angle by operating the mouse to cause the mouse cursor to move to a position of the slider bar 302a and performing a drag operation there in an upward direction. Also, it is possible for a user to decrease the tilt angle by operating the mouse to cause the mouse cursor to move to a position of the slider bar 302a and performing a drag operation there in a downward direction. In other words, by causing the position of the slider bar 302a to move to a desired position, a tilt angle corresponding to that position is instructed. The position of the slider bar 302a is obtained from a range of a current tilt angle and angle of view in a driving range of the tilt angle of the image capturing unit 110. As a length of the slider bar 302a, by applying a ratio of the current angle of view to an image capturing space for a capturable tilt direction, the user can grasp, relatively, by how much the image capturing unit 110 can be driven in upward/downward directions.

A slider bar 302b is something for causing the pan angle of the image capturing unit 110 to increase/decrease by causing the slider bar 302b to move left or right. For example, it is possible for a user to decrease the pan angle by operating the mouse to cause the mouse cursor to move to a position of the slider bar 302b and performing a drag operation there in a leftward direction. Also, it is possible for a user to increase the pan angle by operating the mouse to cause the mouse cursor to move to a position of the slider bar 302b and performing a drag operation there in a rightward direction. In other words, by causing the position of the slider bar 302b to move to a desired position, a pan angle corresponding to that position is instructed. The position of the slider bar 302b is obtained from a range of a current pan angle and angle of view in a driving range of the pan angle of the image capturing unit 110. As a length of the slider bar 302b, by applying a ratio of the current angle of view to an image capturing space for a capturable pan direction, the user can grasp, relatively, by how much the image capturing unit 110 can be driven in leftward/rightward directions.

The lengths of the slider bars 302a and 302b generally become shorter as the zoom scaling factor gets larger, and get longer as the zoom scaling factor gets smaller. In FIG. 2, positions of the slider bars 302a and 302b are both central positions in the operable range thereof, and this means that the image capturing unit 110 faces forward.

Note that, at regular intervals during a drag operation with respect to the slider bar 302a (slider bar 302b), the communication command control unit 210 generates a command that indicates instruction content that is instructed in accordance with the operation content, and transmits it to the image capturing device 100 via the network 10. Also, after the drag operation with respect to the slider bar 302a (slider bar 302b) completes, the communication command control unit 210 may generate a command that indicates the instruction content instructed in accordance with the operation content, and transmit it to the image capturing device 100 via the network 10.

It is also possible to obtain an effect similar to an operation with respect to the slider bar 302a or the slider bar 302b if buttons 303 provided at both ends of the operable range of the slider bar 302a and both ends of the operable range of the slider bar 302b are clicked. In other words, it is possible to cause the tilt angle to increase when the button 303 positioned on the top side of the operable range of the slider bar 302a is clicked. Also, it is possible to cause the tilt angle to decrease when the button 303 positioned on the bottom side of the operable range of the slider bar 302a is clicked. Also, it is possible to cause the pan angle to decrease when the button 303 positioned on the left side of the operable range of the slider bar 302b is clicked. Also, it is possible to cause the tilt angle to increase when the button 303 positioned on the right side of the operable range of the slider bar 302b is clicked.

In this way, if a user operates any of the buttons 301, 303 and 304 or the slider bars 302a and 302b, the communication command control unit 210 generates a command in accordance with that operation, and transmits it to the image capturing device 100 via the network 10. Then the camera driving control unit 120 receives this command via the communication command control unit 130, and controls an image capturing parameter of the image capturing unit 110 in accordance with the received command. In this way, by operating the user interface 299 by a user, the image capturing parameters of the image capturing unit 110 can be controlled.

Current image capturing parameters and a current driving state of the image capturing unit 110 are displayed in an area 306. These “current image capturing parameters” and “current driving state of the image capturing unit 110” are acquired by the communication command control unit 210 from the camera driving control unit 120. The image display control unit 220 displays, in the area 306, the “current image capturing parameters” and “current driving state of the image capturing unit 110” acquired from the camera driving control unit 120 by the communication command control unit 210.

Note that a method for designating an image capturing parameter is not limited to a method that designates by operation of a button or a slider bar as described above, and another method may be employed. For example, assume that a user operates a mouse to cause a mouse cursor to move to a position in the display area 305, and then performs a click operation there. The communication command control unit 210 may be configured to generate and transmit a command for changing the image capturing parameters so that the position of the mouse cursor at that point in time becomes the center position of the display area 305 (click centering) in such a case.

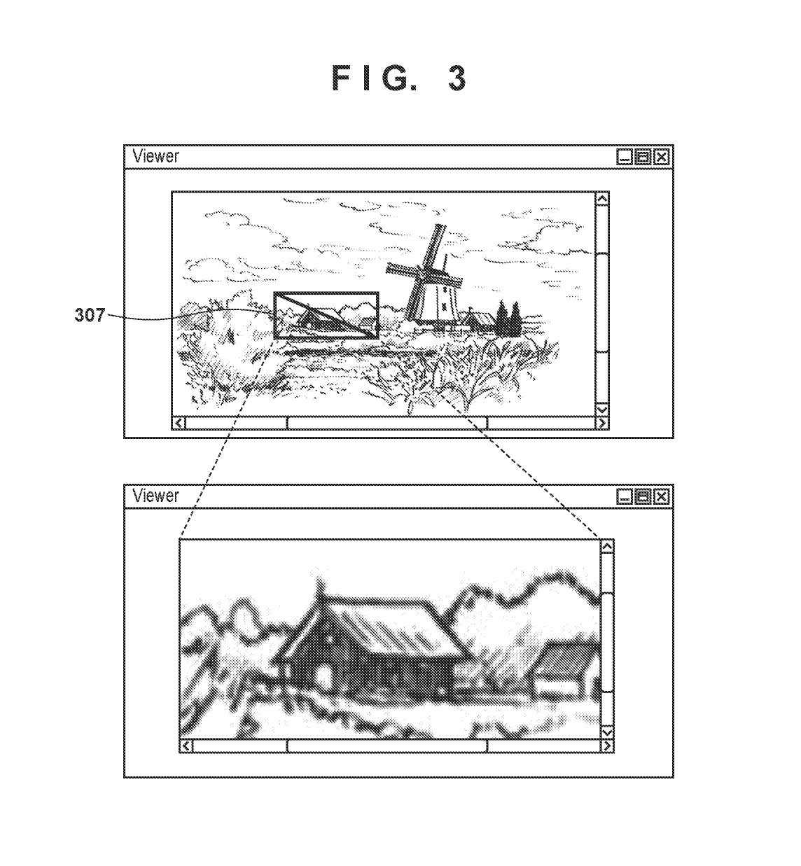

Also, assume that a user operates the mouse to set on the display area 305 a box having as a diagonal thereof a line segment connecting two points, as illustrated in FIG. 3. The communication command control unit 210 may be configured so as to generate and transmit an image capturing parameter such that an area in the rectangle becomes the imaging range (set an imaging range in rectangular as the angle of view) (box zoom) in such a case.

A method for operating image capturing parameters performed via the user interface 299, as explained using FIG. 2 and FIG. 3 above, is something that has been performed conventionally. Here, setting of an image capturing parameter is broadly divided in two as follows in accordance with a time-lag between operation timing, and command generation/transmission timing.

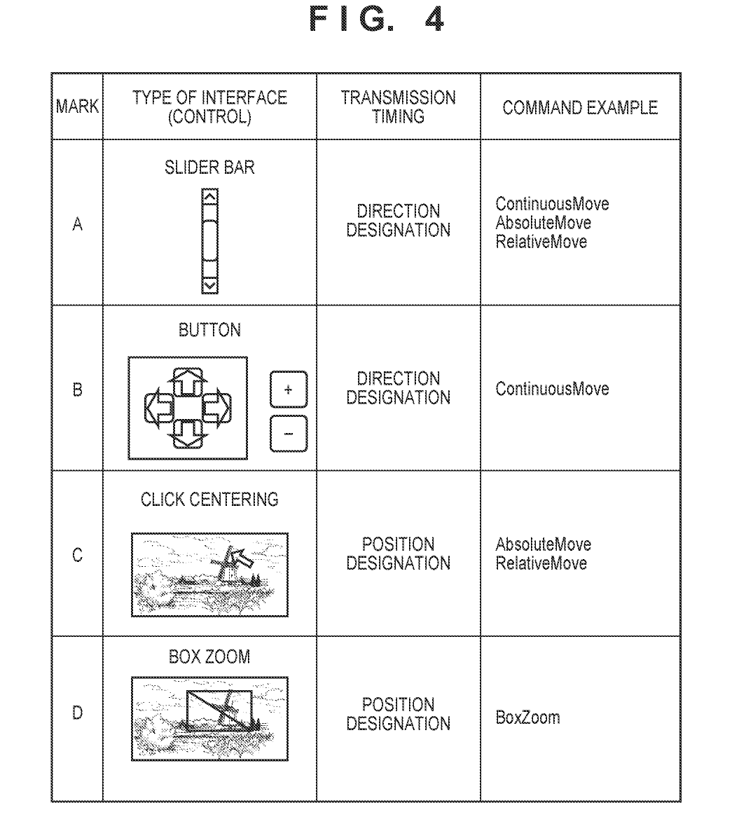

The first is a method for operating in which a command is immediately generated and transmitted when there is input of an operation by a user. An operation for controlling image capturing parameters of the image capturing unit 110 by using the slider bars 302a and 302b or the buttons 301, 303 and 304, as illustrated by A and B of the table of FIG. 4, may be this kind of method for operating.

“ContinuousMove”, a command among commands generated by operating the slider bars 302a and 302b and the buttons 301, 303 and 304, is a command for designating a driving direction of the image capturing unit 110. The command “ContinuousMove” holds as parameters a pan/tilt/zoom driving direction and speed. Assume the communication command control unit 210 generates the command “ContinuousMove” and transmits it to the image capturing device 100, and the camera driving control unit 120 receives the command “ContinuousMove” via the communication command control unit 130. The camera driving control unit 120 continuously controls the image capturing unit 110 in accordance with the speed and driving direction designated by the command “ContinuousMove” in such a case. If the camera driving control unit 120 receives a stop request (stopping of an operation of a button or a slider bar) from the image display device 200 or a time out duration has elapsed, driving of the image capturing unit 110 in accordance with the command “ContinuousMove” is caused to stop.

The commands “AbsoluteMove” and “RelativeMove” are commands that designate a driving direction of the image capturing unit 110 by an absolute position designation and a relative position designation, respectively. The commands “AbsoluteMove” and “RelativeMove” each have as parameters a pan/tilt/zoom driving position and speed. Absolute position designation means designating, by designating a driving position in the movable range of the image capturing unit 110, the pan angle=α (−θ≦α≦θ) (degrees), in a case in which the target of the driving is a pan angle for example, and if a movable range of the pan angle of the image capturing unit 110 is −θ (degrees) to θ (degrees). Of course, configuration may be taken such that, by normalizing a movable range to be −1 to 1, a driving position is designated within that range. Meanwhile, relative position designation is designating a relative driving position from a current driving position. For example, if the driving target is a pan angle, and if it is desired to only change the pan angle Δα (degrees) from the current pan angle=α (degrees) of the image capturing unit 110, Δα is designated.

As described above, at regular intervals during a drag operation of the slider bars 302a and 302b, a command (“ContinuousMove”, “AbsoluteMove”, “RelativeMove”) indicating instruction content instructed by the operation content is generated. In addition, each time the buttons 301, 303 and 304 are clicked, a command (“ContinuousMove”) indicating instruction content instructed by the clicked button is generated. In this way, commands are generated immediately in accordance with operations with respect to the slider bars 302a and 302b and the buttons 301, 303 and 304.

In contrast, there is a method for operating in which a command is generated and transmitted, after all input of operations by a user has completed, or after processing according to operation input by a user has completed. Operations for controlling a driving position of the image capturing unit 110 by operations such as click centering or a box zoom, as illustrated by C and D of the table in FIG. 4, may be of this kind of method for operating.

In click centering, so that a designated position that is designated by a user in the display area 305 becomes a center position of the display area 305, a movement amount from the designated position to the center position is calculated. A command “AbsoluteMove” or “RelativeMove” that has a parameter indicating the calculated movement amount is generated. In this way, in click centering, it is not the case that a command is immediately generated after a user has designated a position in the display area 305, rather a command is generated after processing to obtain a movement amount from the designated position to the center position has completed.

In a box zoom, a command “BoxZoom” having parameters that indicate a position (x1, y1) first designated by a user in the display area 305, a position (x2, y2) next designated, and a speed, are generated. Configuration may be taken such that x1, y1, x2, and y2 are values in the case in which a length in a vertical direction and a length in a horizontal direction of the display area 305 are normalized to be −1 to 1, and configuration may be taken such that they are expressed by information of angles or the like. In this way, in a box zoom there is a need to designate two points that are to designate a rectangle, and a command is generated not just with the first point, but after designation of the next point has completed.

In this way, in designation of an image capturing parameter by click centering or a box zoom, it is difficult to correctly designate one or two points on the display area 305 during driving (while the pan angle, tilt angle, or zoom is changing) of the image capturing unit 110.

In the present embodiment, regarding operations in which generation and transmission of a command is performed after input of all operation input by a user has completed or after processing in accordance with an input of an operation by a user has completed, such as click centering or a box zoom, they are dealt with as follows.

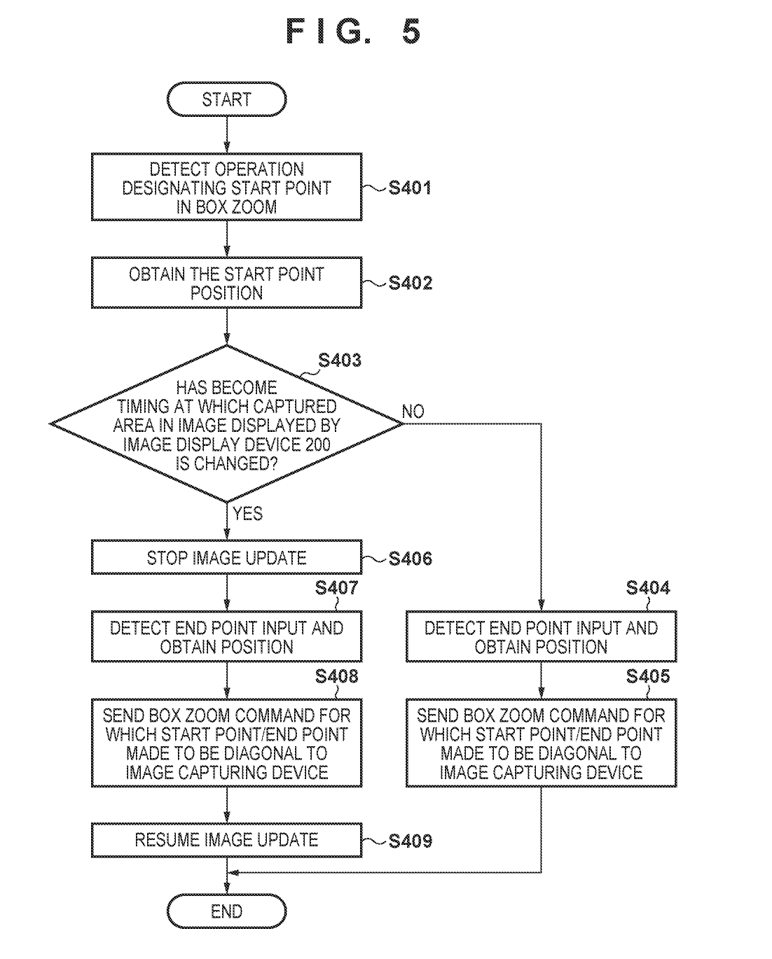

Specifically, if such an operation is started, control is performed such that an image received from the image capturing device at timing in accordance with the start is repeatedly displayed on the display screen 298. Upon completion of the operation, control is performed such that a received image that is received from the image capturing device after the completion is caused to be displayed on the display screen 298. Explanation is given for operation of the image display device 200 in a case in which an operation that designates an image capturing parameter by a box zoom has been performed using a flowchart of FIG. 5.

Step S401

If a user operates the input detection unit 230 to perform an operation that designates a first point on the display area 305 (on the received image), the communication command control unit 210 detects the operation.

Step S402

The communication command control unit 210 acquires a position P1 of the point designated on the display area 305 by the user operating the input detection unit 230.

Step S403

The communication command control unit 210 determines whether the image capturing unit 110 is currently during PTZ driving (during a change of any of pan angle, tilt angle, or zoom). The camera driving control unit 120 manages whether the image capturing unit 110 is currently being driven as a “driving state”, and regularly or irregularly transmits this “driving state” to the image display device 200. The communication command control unit 210 determines whether the image capturing unit 110 is currently being driven by determining whether the “driving state” acquired from the camera driving control unit 120 indicates “during driving” or whether it indicates “during non-driving”.

Note that, as a function that the image capturing unit 110 implements during current PTZ driving, there a function such as that below. For example, there is a function called a preset cycle or a cycle. A preset cycle is a function in which capturing is performed by periodically cycling through a plurality of image capturing directions designated by a user.

In addition, there are the functions of auto-pan driving and auto-tilt driving. An auto-pan function is a function in which an image capturing direction is automatically changed from a leftward to a rightward direction, or from a rightward to a leftward direction. An auto-tilt function is a function in which an image capturing direction is automatically changed from an upward to a downward direction, or from a downward to an upward direction. The image capturing device 100 in the present embodiment may have functions such as these.

In this way, in step S403, it is determined whether it has become a timing at which an image displayed by the image display device 200 is changed from an image that has captured a first area to an image that has captured a second area different to the first area.

For example, configuration may be taken such that it is determined whether it has become a timing at which an image captured by a first image capturing device is changed to an image captured by a second image capturing device, which captured another area.

Of course, configuration may be taken such that it is determined whether the image capturing unit 110 is currently being driven, by the communication command control unit 210 querying, with respect to the image capturing unit 110, whether the image capturing unit 110 is currently being driven.

If the result of the determination is that the image capturing unit 110 is currently being driven, the processing proceeds to step S406; if the image capturing unit 110 is not currently being driven, the processing proceeds to step S404.

Step S404

This step is executed if it is determined by the communication command control unit 210 that the image displayed by the image display device 200 has not changed from an image that captured a first area to an image that captured a second area. When a user operates the input detection unit 230 to perform an operation that designates a next point on the display area 305, the communication command control unit 210 detects the operation, and acquires a position P2 of the designated point.

Step S405

The communication command control unit 210 generates a command “BoxZoom” that has as parameters the position P1 and the position P2, so as to cause a zoom-up to an area in the rectangle having a line segment that connects the position P1 and the position P2 as a diagonal. The communication command control unit 210 then transmits the generated command “BoxZoom” to the image capturing device 100 (the camera driving control unit 120) via the network 10.

Step S406

This step is executed if it is determined by the communication command control unit 210 that the image displayed by the image display device 200 has not changed from an image that captured a first area to an image that captured a second area. In this step, control is performed so as to continue to repeatedly display, in the display area 305, an image of one frame recently received from the image capturing device 100. Various methods can be considered for such control. For example, the image display control unit 220 holds as a target image an image of one frame acquired from the image capturing device 100 within a predetermined interval or immediately after any of the processing of the detection of the operation in step S401, the position acquisition in step S402, or the determination of whether it is during driving in step S403. The image display control unit 220 then repeatedly displays the target image in the display area 305 until a later described condition is satisfied. Configuration may be taken such that the image capturing device 100 is instructed so as to cause driving to stop, by the communication command control unit 210 transmitting a Stop command to the image capturing device 100, for example. That is, configuration may be taken such that the image capturing device 100 does not change the angle of view, by the communication command control unit 210 transmitting a Stop command to the image capturing device 100. In other words, in a case of executing a function such as a preset cycle, auto-pan, or auto-tilt, the function is temporarily stopped. In addition, configuration may be taken so as to cancel or to delay execution of a function such as a preset cycle, auto-pan, or auto-tilt.

In accordance with such control, even if the image capturing device 100 is during driving (during a change of an imaging range), a still image (the target image) is displayed on the display screen 298 (changing the display of a captured image is suppressed). Consequently, a user can accurately perform an operation for a box zoom on the still image.

Step S407

When a user operates the input detection unit 230 to perform an operation that designates a next point on the display area 305, the communication command control unit 210 detects the operation, and acquires a position P2 of the designated point.

Step S408

The communication command control unit 210 generates a command “BoxZoom” that has as parameters the position P1 and the position P2, so as to cause a zoom-up to an area in the rectangle having a line segment that connects the position P1 and the position P2 as a diagonal. The communication command control unit 210 then transmits the generated command “BoxZoom” to the image capturing device 100 (the camera driving control unit 120) via the network 10.

Step S409

In this step, control is performed so as to display in the display area 305 an image of frames from the target image onwards, in other words images sequentially transmitted from the image capturing device 100. If the communication command control unit 210 transmitted a Stop command to the image capturing device 100 in step S406, the image capturing device 100 does not need to subsequently perform any processing in this step for causing driving based on a command “BoxZoom” particularly. If the target image was repeatedly displayed in step S406, the image display control unit 220 displays on the display area 305 images of each frame received from the image capturing device 100 immediately after a time at which processing proceeded to this step, or received following the elapse of a predetermined time.

Note that, after the processing of step S406, if cancel processing occurs due to processing circumstances or a user instruction, the processing proceeds to step S409 immediately. Also, configuration is taken such that, similarly, cancel processing occurs, and the Stop command is transmitted to the image capturing device 100 in step S406. In this case, a driving operation (a driving operation in accordance with commands “AbsoluteMove”, “RelativeMove”, “ContinuousMove”, or the like) being executed beforehand is caused to resume. In addition, configuration may be taken to cause driving in accordance with a command “GotoPreset”, which causes PTZ driving to a registered position.

Note that the flowchart of FIG. 5 is for a box zoom, but in the case of click centering, instead of an operation to acquire the position P2 (step S404 and step S407) processing that calculates a movement amount based on the position P1 is performed. Parameters of commands transmitted in step S405 and step S408 are parameters that indicate a movement amount instead of the position P1 and the position P2.

First Variation

The input detection unit 230 may be a touch panel. In such a case, a touch panel is integrated with the display screen 298 as the input detection unit 230, and the input detection unit 230 detects a drag operation or a position touched on the display screen 298. In such a case a user can directly operate a button or slider bar on the user interface 299 of FIG. 2, which is displayed on the display screen 298.

Second Variation

A configuration of the user interface 299 of FIG. 2 is an example, and a method for designating a pan angle, a tilt angle, and a zoom is not limited to operation of a button or slider bar illustrated in FIG. 2. In addition, the user interface 299 of FIG. 2 may be configured from two or more screens, and for example may use a user interface that separates a screen in which buttons and slider bars are arranged from a screen for displaying an image from the image capturing device 100.

Also, in the present embodiment, the display screen 298 was given as a display screen integrated with the image display device 200, as illustrated in FIG. 1, but it may be a display screen in an apparatus separate from the image display device 200.

### Second Embodiment

In the present embodiment, if during driving is determined in step S403, in addition to continuing to repeatedly display in the display area 305 an image of one frame recently received from the image capturing device 100, a reduced image of an image sequentially transmitted from the image capturing device 100 in this period is also displayed. Below, explanation is given predominantly regarding differences with the first embodiment, and to the extent that something is not touched upon particularly below, it is the same as in the first embodiment.

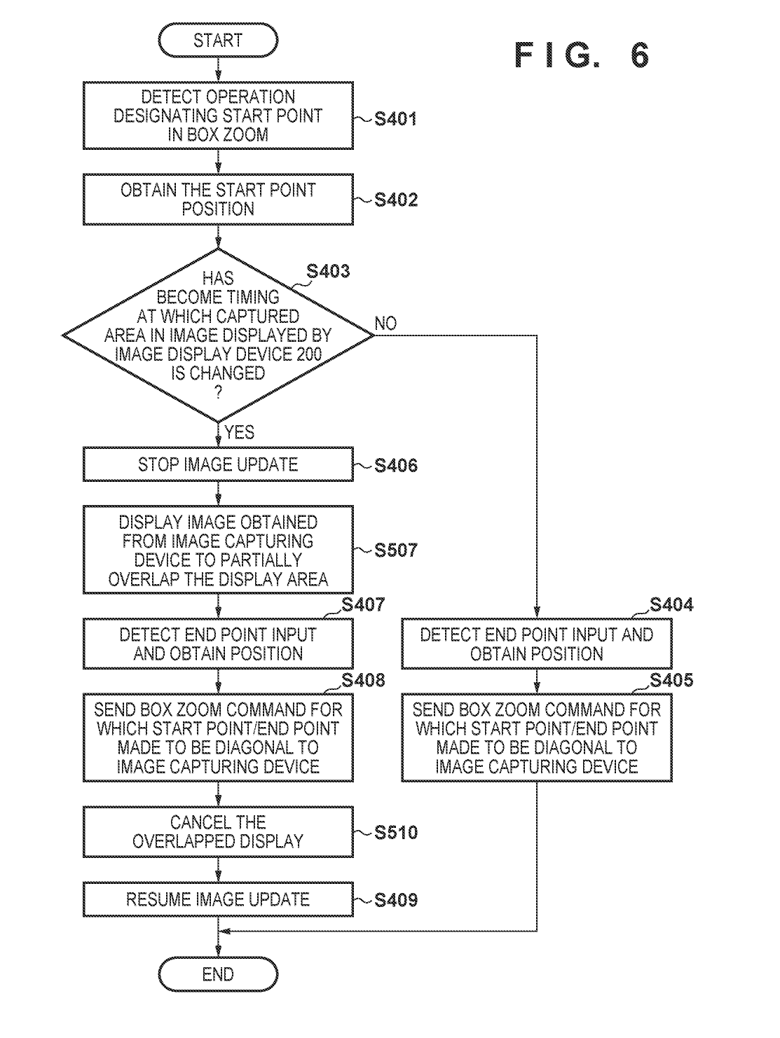

Explanation is given for operation of the image display device 200 in a case in which an operation that designates an image capturing parameter by a box zoom has been performed using a flowchart of FIG. 6. In FIG. 6, the same step number is given to processing steps that are the same as the processing steps illustrated in FIG. 5, and an explanation for these processing steps is omitted.

Step S507

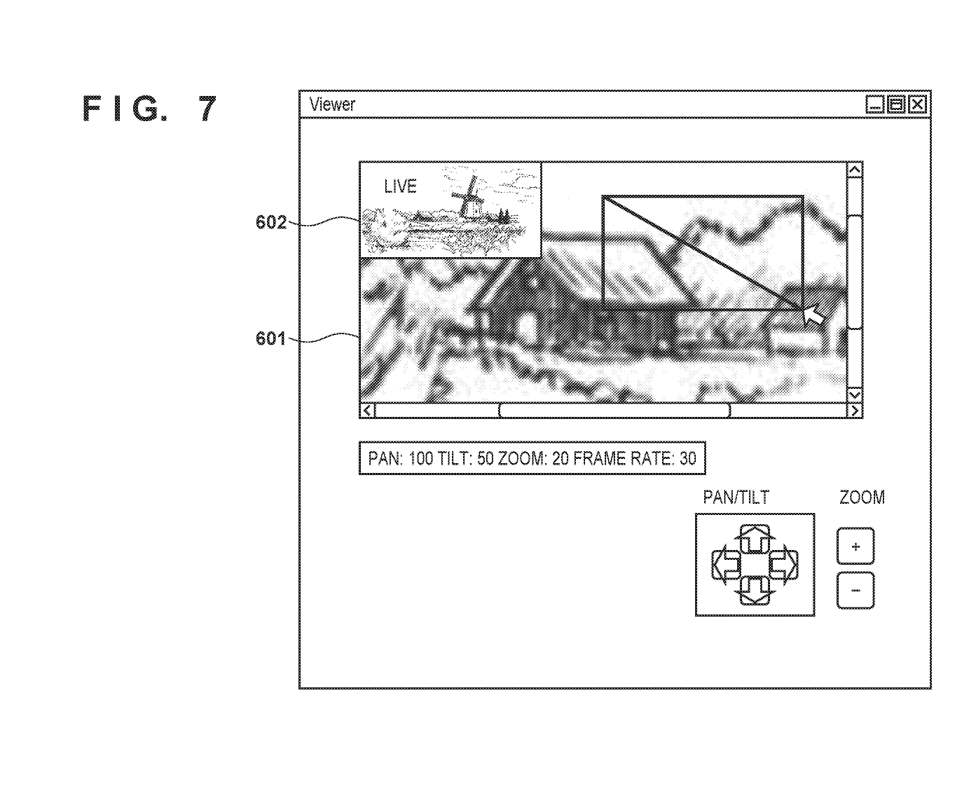

The image display control unit 220 reduces an image sequentially received from the image capturing device 100, and displays the reduced image at a position in the display area 305. For example, as illustrated in FIG. 7, a reduced image 602 is displayed at a position of an upper left corner of the display area 305, overlapping a target image 601. In FIG. 7, to indicate that the reduced image 602 is a live image, the text “LIVE” is displayed overlapping the reduced image 602. Note that the reduced image 602 may be displayed semi-transparently.

Note that, in this step, limitation is not made to a method of displaying by overlapping the reduced image if it is possible to display the live image from the image capturing device 100 to enable it to be viewed along with the target image. For example, configuration may be taken such that the live image is displayed on a window that is separate from the user interface 299.

Step S510

The image display control unit 220 terminates display of the reduced image, and sets the reduced image to non-display.

In this way, by virtue of the present embodiment, similarly to the first embodiment, even if the image capturing device 100 is during driving, because what is displayed on the display screen 298 is a still image (the target image), a user can accurately perform an operation for a box zoom on the still image. In addition, in the present embodiment, it is also possible to check images sequentially transmitted from the image capturing device 100 (the live image).

### Third Embodiment

In the first and second embodiments, upon finalization of parameters designated by click centering or a box zoom during driving of the image capturing device 100, the parameters are transmitted to the image capturing device 100. In the present embodiment, a parameter finalized in this way is not immediately transmitted to the image capturing device 100, but is saved as pre-set data. For example, registering several locations is necessary for causing the image capturing device 100 to perform a preset cycle (for each of the several locations, it is necessary to set parameters for capturing the location). Thus, various locations are caused to be captured while causing the image capturing parameters of the image capturing device 100 to change, and at a stage at which a location that should be registered for a preset cycle is captured, a user designates the location by a box zoom or click centering in the display area 305. By repeating this, it is possible to register several locations for the preset cycle. Below, explanation is given predominantly regarding differences with the first embodiment, and to the extent that something is not touched upon particularly below, it is the same as in the first embodiment.

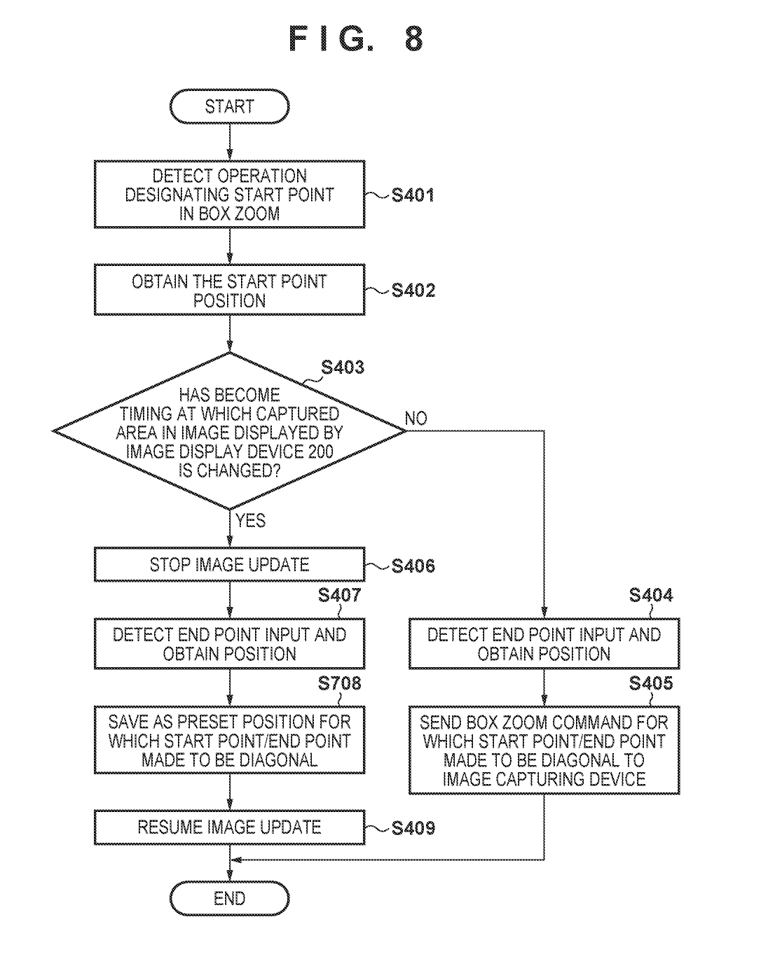

Explanation is given for operation of the image display device 200 in a case in which an operation that designates an image capturing parameter by a box zoom has been performed using a flowchart of FIG. 8. In FIG. 8, the same step number is given to processing steps that are the same as the processing steps illustrated in FIG. 5, and an explanation for these processing steps is omitted.

Step S708

The communication command control unit 210 saves the position P1 and the position P2 as pre-set data in a memory of the apparatus. The save destination may be a memory in the image capturing device 100, and the save destination is not limited to a particular save destination.

When performing a preset cycle, positions saved as pre-set data in this memory are transferred to the image capturing device 100, and the camera driving control unit 120 controls the image capturing parameters of the image capturing unit 110, based on the transferred positions, to cause the preset cycle to be realized.

Of course, in the present embodiment, similarly to the first embodiment, even if the image capturing device 100 is during driving, because what is displayed on the display screen 298 is a still image (the target image), a user can accurately perform an operation for a box zoom on the still image.

### Fourth Embodiment

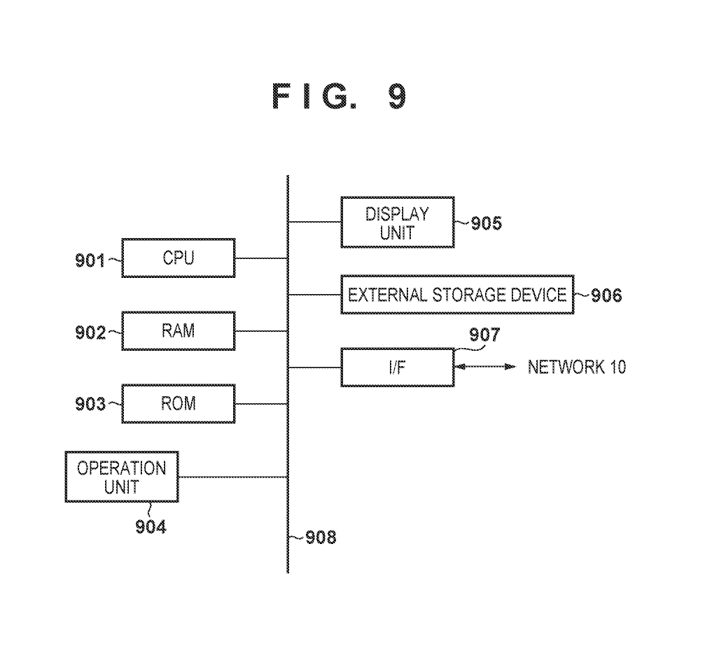

Of the functional units of the image display device 200 illustrated in FIG. 1, each of the communication command control unit 210, the image display control unit 220 and the input detection unit 230 can be configured by dedicated hardware, but the functions of some of these may be configured by software. In such a case, a computer apparatus having a hardware configuration as exemplified in FIG. 9 can be applied to the image display device 200. In other words, configuration may be taken such that the processing illustrated by FIG. 5, FIG. 6 and FIG. 8 and performed by some or all of the units illustrated in FIG. 1 is configured by a computer program, and a computer apparatus having the hardware configuration illustrated in FIG. 9 executes the computer program.

A CPU 901 executes or controls processing by using data and a computer program stored in a ROM 903 or a RAM 902. Thus the CPU 901 performs operation control of the computer apparatus overall, and in addition executes or controls the processing described above as something that the image display device 200 performs.

The RAM 902 has an area for storing data or a computer program loaded from the ROM 903 or an external storage device 906, and various data received from the image capturing device 100 via an I/F (interface) 907. Furthermore the RAM 902 has a work area used when the CPU 901 executes various processing. In this way the RAM 902 can appropriately provide various areas. The ROM 903 stores a boot program or setting data of the computer apparatus that does not need to be rewritten.

An operation unit 904 is configured by a mouse, a keyboard, or the like, and can input various instructions to the CPU 901 by a user of the computer apparatus operating it. The operation unit 904 functions as the input detection unit 230 of FIG. 1, for example.

A display unit 905 is configured by a CRT, a liquid crystal screen, or the like, and can display a result of the processing by the CPU 901 by an image, text, or the like. For example, the display unit 905 can display the user interface 299 as is exemplified in FIGS. 2, 3, and 7. Note that the operation unit 904 may be a touch panel, and in that case, the operation unit 904 and the display unit 905 can be caused to be integrated to configure a touch panel screen.

The external storage device 906 is a large capacity information storage device as typified by a hard disk drive device. The external storage device 906 saves an OS (operating system), and data and a computer program for causing the CPU 901 to execute or control the processing described above as something the image display device 200 performs. This computer program includes a computer program for causing the CPU 901 to execute or control processing in accordance with the flowcharts illustrated in FIGS. 5, 6 and 8, and a computer program of the user interface 299. In addition, the data includes various setting data and information treated as known information in the above explanation. Computer programs and data saved in the external storage device 906 are appropriately loaded into the RAM 902 in accordance with control by the CPU 901, and become a target of processing by the CPU 901.

The I/F 907 performs data communication with the image capturing device 100 via the network 10. All of the aforementioned units are connected to a bus 908. Note that the configuration illustrated in FIG. 9 is merely an example configuration of a computer apparatus that can be adapted to the image display device 200. Some of the configurations or all of the configurations of the aforementioned embodiments may be appropriately used in combination, and the some or all of the configurations may be selectively used.

By virtue of each of the above embodiments, it is possible to suppress a change of display of a captured image due to a change of an image capturing parameter.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-131842, filed Jun. 30, 2015, which is hereby incorporated by reference herein in its entirety.

What is claimed is:

1. A display control apparatus, comprising:
an acquisition unit configured to acquire a captured image that is captured by an image capturing device;
a display control unit configured to cause the captured image acquired by the acquisition unit to be displayed in a display screen; and
an operation acceptance unit configured to accept a predetermined operation in a state in which the captured image is displayed in the display screen,
wherein
if, in a case where the predetermined operation is performed, the display control unit determines that it has become a timing at which the captured image displayed in the display screen is changed from a first captured image obtained by capturing a first area to a second captured image obtained by capturing a second area different to the first area, the display control unit causes the first captured image to be displayed in the display screen without changing to the second captured image until at least the predetermined operation terminates.

2. The display control apparatus according to claim 1, wherein
the image capturing device determines whether the captured image displayed in the display screen is changed from the first captured image to the second captured image by determining whether an angle of view of the captured image captured by the image capturing device is changed.

3. The display control apparatus according to claim 1, wherein
the image capturing device determines whether the captured image displayed in the display screen is changed from the first captured image to the second captured image by determining whether the captured image displayed in the display screen is changed from a captured image captured by a first image capturing device to a captured image captured by a second image capturing device different to the first image capturing device.

4. The display control apparatus according to claim 1, further comprising
an output unit configured to output to the image capturing device, when the predetermined operation terminates, a command in accordance with the predetermined operation,
wherein the display control unit, when the predetermined operation terminates, causes the captured images, acquired by the acquisition unit from when the command is outputted by the output unit, to be displayed in the display screen.

5. The display control apparatus according to claim 1, wherein
the predetermined operation is an operation for changing a parameter in the image capturing device.

6. The display control apparatus according to claim 5, wherein
the parameter is a parameter for an angle of view of the image capturing device.

7. The display control apparatus according to claim 5, further comprising
a saving unit configured to, after the changing of the parameter has completed, save the changed parameter as a parameter for a preset cycle.

8. The display control apparatus according to claim 1, wherein the first captured image is a captured image received from the image capturing device immediately after starting of the predetermined operation, or within a predetermined period immediately after starting of the predetermined operation.

9. The display control apparatus according to claim 1, wherein the predetermined operation is an operation for designating one point on the captured image displayed in the display screen, and is an operation for instructing generation of a command that changes a parameter in the image capturing device such that the one point becomes a center of an angle of view.

10. The display control apparatus according to claim 1, wherein the predetermined operation is an operation for designating at least two points on the captured image displayed in the display screen, and is an operation for instructing generation of a command for changing a parameter in the image capturing device such that a rectangle, having as a diagonal a line segment that connects the two points, becomes an imaging range.

11. The display control apparatus according to claim 1, wherein if the predetermined operation is started, the display control unit reduces a captured image received from the image capturing device after the predetermined operation, and causes the reduced image to be displayed in the display screen.

12. The display control apparatus according to claim 1, wherein
if, in a case where the predetermined operation is performed, the display control unit determines that the captured image displayed in the display screen is changed from a first captured image obtained by capturing a first area to a second captured image obtained by capturing a second area different to the first area, the display control unit causes a captured image received from the image capturing device at a timing at which the predetermined operation is detected to be started to be displayed in the display screen repeatedly.

13. A display control method, comprising:
acquiring a captured image that is captured by an image capturing device;
performing a display control to cause a display screen to display the captured image; and
accepting a predetermined operation in a state in which the captured image is displayed in the display screen, wherein
if, in a case where the predetermined operation is performed, it is determined in the display control that it has become a timing at which the captured image displayed in the display screen is changed from a first captured image obtained by capturing a first area to a second captured image obtained by capturing a second area different to the first area, the first captured image is caused to be displayed in the display screen without changing to the second captured image until at least the predetermined operation terminates.

14. A non-transitory computer-readable storage medium storing a computer program for causing a computer to function as:
an acquisition unit configured to acquire a captured image that is captured by an image capturing device;
a display control unit configured to cause the captured image acquired by the acquisition unit to be displayed in a display screen; and
an operation acceptance unit configured to accept a predetermined operation in a state in which the captured image is displayed in the display screen,
wherein
if, in a case where the predetermined operation is performed, the display control unit determines that it has become a timing at which the captured image displayed in the display screen is changed from a first captured image obtained by capturing a first area to a second captured image obtained by capturing a second area different to the first area, the display control unit causes the first captured image to be displayed in the display screen without changing to the second captured image until at least the predetermined operation terminates.
